(19) United States
(12) Patent Application Publication
(10) Pub. No.: US 2017/0164702 A1
(43) Pub. Date: Jun. 15, 2017

(54) PRODUCT AND METHOD FOR A PLASTIC BAG COMPRISING INORGANIC MATERIALS

(71) Applicant: Steve Kohn, Short Hills, NJ (US)

(72) Inventor: Steve Kohn, Short Hills, NJ (US)

(73) Assignee: Broadway Holding II, LLC

(21) Appl. No.: 15/093,187

(22) Filed: Apr. 7, 2016

Related U.S. Application Data
(60) Provisional application No. 62/386,895, filed on Dec. 15, 2015.
(60) Provisional application No. 62/387,102, filed on Dec. 21, 2015.

(51) Int. Cl. A45C 3/04; C08L 23/06; B65D 33/28; B65D 33/00; B65D 33/06

(52) U.S. Cl. CPC A45C 3/04; B65D 33/004; B65D 33/065; B65D 33/28; C08L 23/06; C08L 2201/06; C08L 2205/025; C08L 2205/03; C08L 2207/062; C08L 2207/066

(57) ABSTRACT

Products and methods for producing products which comprise polyethylene and inorganic minerals for a single layer plastic bag.

### RELATED APPLICATIONS

The present application is related to Provisional application Ser. No. 62/386,895 filed Dec. 12, 2015 and Provisional Application Ser. No. 62/387,102 filed Dec. 21, 2015.

### FIELD OF THE INVENTION

The present invention relates to products and a method of producing products which comprise polyethylene and inorganic minerals for a single layer plastic bag.

### BACKGROUND OF THE INVENTION

Printed and unprinted flexible and semi-rigid packaging materials are commonly used for packing retail, industrial, and commercial products into plastic bags such as T-sacks. Desired product features of plastic bags include printability and different levels of opacity. The amount and type of resin used, and the thickness, material weight and density of the packaging materials all affect the cost and other characteristics of the plastic bags. Key performance attributes of these packaging materials include substantial barrier protection, product protection and containment, shipping, storage, and dispensing applications. Barrier protection refers to the ability of a packaging material to stop or retard the passage of atmospheric gases or water vapor into the material from the outside environment. The prior art uses metalizing to provide a lustrous metallic appearance, that when applied to plastic film, improves gas and light barrier properties of the film.

Polyethylene (PE) film has been used in the prior art on preparation of bags because of its transparency, toughness, heat seal-ability, low water vapor transmission rate, low temperature performance and low cost. PE films are highly permeable to oxygen and other non-polar gases and have high viscoelastic flow properties.

Polypropylene (PP) film is a transparent, tough, thermoplastic film. Un-oriented film is soft and becomes brittle at low temperature, however this property as well as strength, stiffness, and clarity can be improved by orientation e.g. bi-axially oriented polypropylene (BOPP). Polystyrene film is a transparent, stiff film of high permeability and moderate temperature resistance that can be oriented to improve strength. Films can also be made of polyamide (PA). PA is used almost entirely as a film or sheet material in packaging applications. The clear film offers a good oxygen barrier, and is particularly tough and abrasion resistant. However, PA film is a poor moisture barrier, does not heat seal, and has cost disadvantages. Films can also be made of polychlorotrifluoroethylene (PCTFE or CTFE), which is a plastic material characterized by exceptional moisture and good oxygen barrier characteristics as well as good clarity.

A problem that exists with prior films is that these products do not incorporate low cost, environmentally friendly materials and designs. Environmentally friendly materials can have desirable attributes such as biodegradability, compostability, and recyclability, and may also use less energy, pollute less, and generate fewer greenhouse gases in their manufacture than previous materials. Such environmentally friendly materials are increasingly in demand from consumers and retailers.

Another significant problem that exists with prior flexible film packaging is the high concentration of expensive plastic and polymers required to achieve the performance specifications needed. Yet another problem is the very expensive combinations of plastics, foils, coatings, and metalized films to achieve structural, barrier, sealing and printability aspects.

U.S. Pat. No. 8,507,581 relates to a stone based copolymer substrate which includes calcium carbonate from approximately 50-85% by weight varying in size generally from 1.0 to 3.0 microns; HDPE from approximately 2-25% by weight; and a biopolymer from approximately 2-25% by weight. The biopolymer may include a polymer of lactic acid (PLA), polyhydroxybutanoate (PHB), polyhydroxyalkanoates (PHA), Nylon 611 and Polyactic Acid.

U.S. Pat. No. 8,569,411 is directed to flexible packaging composites which include one or more mineral-containing layers with thermoplastic bonding agent. The composite may also contain one or more non-mineral containing layers, including various combinations of extruded resins, cast or blown films, and fibers. The mineral-containing layer is substantially and continuously bonded to the other layers. The polymer, fiber and mineral containing layers can be made such that the resulting composite structure can be machined to form a storage article. The specification provides that the bonding agents can include, but are not limited to, HDPE, and another bonding agent that is a high molecular weight high density polyethylene. The film composite comprises: at least one mineral-containing layer containing a thermoplastic bonding agent in an amount of about 15-30% by weight and a mineral material that is present in an amount of about 70-85% by weight. The film composite comprises: at least one mineral-containing layer bonded to said at least one non mineral-containing layer, said at least one mineral-containing layer containing a thermoplastic bonding agent in an amount of about 15-30% by weight and a mineral material that is present in an amount of about 70-85% by weight. The film composite comprises: at least one mineral-containing layer that is at least 0.5 mil in caliper containing a thermoplastic bonding agent in an amount of about 15-30% by weight and a mineral content that is present in an amount of about 70-85% by weight.

U.S. Pat. No. 8,177,066 is directed to a high visual impact plastic packaging, wherein plasticized or laminated paperboard materials can be used, as well as plastic materials such as mineral-based materials, polyactic acid, and recycled or recyclable polyurethane. The packaging is created into separate portions that include blister portions, cavity portions, windows and holes, and compacted regions.

U.S. Pat. No. 9,062,190 is directed to a stone based copolymer substrate which includes calcium carbonate from approximately 50-85% by weight and varying in size generally from 1.0 to 3.0 microns; HDPE from approximately 2-25% by weight; and a biopolymer from approximately 2-25% by weight.

U.S. Patent Publication 2013/0227881 is directed to a recycled plastic composite composition which includes a recycled EVA 30% to 80% by weight and a stone powder from 20% to 70% by weight.

U.S. Patent Publication 2009/0047499 is directed to a multi-layer composite structure and storage article made therefrom, which includes a fiber-containing layer, such as a fiberboard layer or other layer having fibers from natural or synthetic sources, and a ground calcium carbonate-containing layer covering the fiber-containing layer. The extruded calcium carbonate containing layer comprising at least 30% by weight of the thermoplastic bonding agent.

U.S. Patent Publication 2009/0047511 is directed to a multi-layer composite material structure and storage article made therefrom which includes a fiber-containing layer, such as fiberboard layer or other layer having fibers from natural or synthetic sources, and a mineral-containing layer covering the fiber-containing layer.

U.S. Patent Publication 2009/0142528 is directed to a composite structure having at least two layers, comprising less than 25% Polymers, a fiber-containing layer, such as a layer of paperboard or other layer having fibers from natural or synthetic sources, and a mineral-containing layer covering and bonded to the fiber-containing layer.

U.S. Patent Publication 2014/0057061 is directed to a flexible packaging composites having at least two layers which include one or more mineral-containing layers with a thermoplastic bonding agent. A flexible film composite suitable for use as a packaging material for storage of articles, comprising: at least one mineral-containing layer containing a thermoplastic bonding agent and a mineral material. The mineral containing layer is an external most layer of the flexible film composite. The mineral material is selected from the group consisting of ground calcium carbonate, diatomaceous earth, mica, silica, glass, zeolite, slate, and combinations thereof, and at least one layer adhered to the at least one mineral-containing layer by a wet or dry lamination technique. The mineral-containing layer and the at least one other layer form a composite material that is flexible. The mineral material is present in the mineral-containing layer in an amount of up to 85% by weight. The at least one other layer comprises a non-mineral containing layer selected from the group consisting of ink, nylon, a sealant, foil, oriented polypropylene (OPP), metalized oriented polypropylene (OPP), polypropylene, polypropylene terephthalate (PET), a peel and stick label backing, polyethylene, ethylene-vinyl alcohol (EVOH), paper, a fiber material coated with polyethylene, a fiber containing layer, a biodegradable polymer, a photodegradable polymer, and a polyester. The at least one mineral containing layer is sterilizable.

U.S. Patent Publication 2014/0272352 is directed to a composite structure which includes at least one or more fiber-containing layers and one or more mineral-containing layers. The mineral-containing layer comprises a thermoplastic bonding agent fixing the minerals in place. A recyclable composite packaging material, comprising: a fiber-containing layer, and a mineral-containing layer bonded to the fiber-containing layer. The mineral-containing layer comprises a thermoplastic bonding agent and has a mineral content of 20-70 wt %; and wherein thickness and composition of the mineral containing layer are selected to provide a screen cleanliness efficiency of 60% to 100% and a removal efficiency of the mineral containing layer from the fiber-containing layer of 50% to 95% by mass in a repulping recycling operation.

U.S. Patent Publication 2014/0274632 is directed to a composite structure including a fiber-containing layer, such as a fiberboard layer or other layer having fibers from natural and/or synthetic sources, and a mineral-containing layer covering the fiber-containing layer. A composite packaging material, comprising: one or more mineral-containing layer extrusion bonded to a fiber-containing layer; wherein the mineral-containing layer is formed from a mineral containing polymer comprising a polymer composition and a mineral composition.

U.S. Patent Publication 2014/0274633 is directed to a composite structure having at least two layers, including a fiber-containing layer, such as a fiberboard layer or other layer having fibers from natural and/or synthetic sources, and a mineral-containing layer covering the fiber-containing layer.

### SUMMARY OF INVENTION

The present invention relates to the use of a plastic material in combination with environmentally stable materials. The environmentally stable materials are inorganic mineral compounds.

It is an object of the present invention for the inorganic mineral compound to be a calcium carbonate based material.

The present invention relates to a plastic bag comprising: approximately 20-49% calcium carbonate; approximately 30-60% high density polyethylene; approximately 0-20% linear low density polyethylene; and approximately 0-10% fillers/bonding agent. The plastic bag is a single layer. It is an object of the present invention for the plastic bag to further comprise a biopolymer. It is an object of the present invention for the biopolymer to comprise approximately 0.5% to 20% by weight of said plastic bag. It is an object of the present invention for the plastic bag to further comprise a biopolymer in an amount less than 1.5%. It is an object of the present invention for the biopolymer to be selected from the group consisting of: poly lactic acid, poly-hydroxybutanoate, poly-hydroxyalkanoate, Nylon 610, Nylon 611.

It is an object of the present invention for the bag to contain no fibers. It is an object of the present invention for the external surface of the bag to comprise a printable surface. It is an object of the present invention for the external surface of the bag to comprise a smooth surface. It is an object of the present invention for the plastic bag to provide a moisture barrier.

It is an object for the present invention for the bag to comprise printed information. It is an object of the present invention for the bag to comprise a barcode. It is an object of the present invention for the bag to comprise a coupon.

The present invention relates to a plastic bag comprising: approximately 20-49% mineral material; approximately 30-60% high density polyethylene; approximately 0-20% linear low density polyethylene; approximately 0-10% fillers/bonding agents. The plastic bag is a single layer.

It is an object of the present invention for the inorganic mineral compounds to comprise calcium carbonate, calcium sulfate, barium sulfate, kaolin, mica, zinc oxide, dolomite, glass fiber, hollow glass microbead, silica, chalk, talc, pigment, titanium dioxide, bentonite, clay, zeolite, slate, diatomaceous earth and combinations thereof.

It is an object of the present invention for the bags to be a T-sack or T-shirt bag. It is an object of the present invention for the plastic bag to be a die-cut bag, loop-handle bag, tri-fold bag, soft loop flat bag, wave style bag, drawstring bag or drawstring cord bag.

The present invention relates to a plastic bag comprising: approximately 25-40% calcium carbonate; approximately 30-50% high density polyethylene; approximately 5-15% linear low density polyethylene; and approximately 2-7% filler/bonding agent. The plastic bag is a single layer.

The present invention relates to a plastic bag comprising: approximately 20-49% mineral material; approximately 30-60% high density polyethylene; approximately 0-20% low density polyethylene, linear low density polyethylene or a combination thereof; and approximately 0-10% fillers/bonding agent. The plastic bag is a single layer.

The present invention relates to a plastic bag comprising: calcium carbonate, high density polyethylene, linear low density polyethylene, and a filler/bonding agent. The plastic bag is a single layer. It is an object of the present invention for the calcium carbonate to comprise less than 50% by weight of the bag.

The present invention relates to a plastic bag comprising: calcium carbonate, high density polyethylene; low density polyethylene, linear low density polyethylene or a combination; and a filler/bonding agent. The plastic bag is a single layer. It is an object of the present invention for the calcium carbonate to comprise less than 50% by weight of the bag.

It is an object of the present invention for the calcium carbonate based material to be combined with a non-toxic PE resin. It is an object of the present invention for the polyethylene to comprise high density polyethylene, medium density polyethylene, low density polyethylene, linear low density polyethylene or any combination thereof.

It is an object of the present invention that the single layered products can be used for packaging, and bags. It is an object of the present invention for the packaging and bags to have printing.

It is an object of the present invention for the formed materials to have a high degree of pliability and flexibility, and to have a printing surface that readily accepts coating and inks. It is an object of the present invention to use these materials to form printed or unprinted plastic bags. It is an object of the present invention for any of these products to have an antimicrobial component added to it.

It is an object of the present invention for the material to be torn or cut easily so that, for example, a printed coupon can be removed from the material, but strong enough to hold items in the bag.

It is an object of the present invention to use these materials to form plastic T-sacks or T-shirt bags. It is an object of the preset invention for the bag to have a matte and a non-glossy finish. It is an object of the present invention for the bags to be smooth to the touch but not slippery. It is an object of the present invention for the bag to be translucent.

It is an object of the present invention to make the environmental friendly plastic materials into different sizes of T-sacks.

It is an object of the present invention for the T-sacks to be made of either HDPE, LLDPE, or LDPE in combination with an inorganic mineral compound. It is an object of the present invention for handles to be either traditional or wave style or die cut.

It is an object of the present invention for the printed or unprinted T-sacks to have dimensions from approximately 5-20″ wide by approximately 10″-40″ high with approximately a 2″-15″ gusset, with thickness ranging from approximately 0.25-4.0 mil.

It is an object of the present invention that the more calcium carbonate based or inorganic material used in the manufacturing of any of the plastic based products, the greater the required mil thickness of the plastic based product in order to preserve the strength, performance and effectiveness of the plastic based product.

It is an object of the present invention for the printed or unprinted Small T-sack to be approximately 5-8″ wide×10-17″ high with a 2-5″ gusset. It is an object of the present invention for the T-sack to have a thickness of approximately 0.25 to 4.0 mil.

It is an object of the present invention for the printed or unprinted Medium T-sack to measure approximately 8-11″ wide×16-20″ high with a 4-7″ gusset. It is an object of the present invention for the T-sack to have a thickness of approximately 0.35 to 4.0 mil.

It is an object of the present invention for the printed or unprinted Large T-sack to measure approximately 11-14″ wide×20-25″ high with a 6-9″ gusset. It is an object of the present invention for the T-sack to have a thickness of approximately 0.35 to 4.0 mil.

It is an object of the present invention for the printed or unprinted Jumbo T-sack to measure approximately 15-20″ wide×25-40″ high with a 7-15″ gusset. It is an object of the present invention for the T-sack to have a thickness of approximately 0.35 to 4.0 mil.

It is an object of the present invention for the materials to be destroyed eventually by exposure to the sun. It is an object of the present invention for the inorganic mineral material layer to be more biodegradable as more inorganic mineral material is added.

It is an object of the present invention for the bags to be biodegradable. It is an object of the present invention for the bags to be compostable. It is an object of the present invention for the bags to further comprise a biopolymer. It is an object of the present invention for the biopolymer to comprise poly lactic acid, poly-hydroxybutanoate, poly-hydroxyalkanoates, Nylon 610, or Nylon 611. It is an object of the present invention for the biopolymer to comprise approximately 0.5% to 20% by weight of said plastic bag. It is an object of the present invention for the biopolymer to comprise no more than 1.5% of the bag.

It is an object of the present invention for the filler/bonding agent to comprise a polymer.

It is an object of the present invention for the bonding agent to be photodegradable.

### BRIEF DESCRIPTION OF DRAWINGS

FIG. 1 is an embodiment of a T-sack of the present invention.

FIG. 2 is an embodiment of a T-sack of the present invention.

FIG. 3 is an embodiment of a T-sack of the present invention.

FIG. 4 is an embodiment of a T-sack of the present invention.

FIG. 5 is an embodiment of a die cut bag of the present invention.

FIG. 6 is an embodiment of a drawstring bag of the present invention.

FIG. 7 is an embodiment of a loop handle bag of the present invention.

FIG. 8 is an embodiment of a wave style bag of the present invention.

FIG. 9 is an embodiment of a drawstring bag of the present invention.

FIG. 10 is a front view of a T-sack of the present invention.

FIG. 11 is a font view of a die cut bag of the present invention.

### DETAILED DESCRIPTION OF THE INVENTION

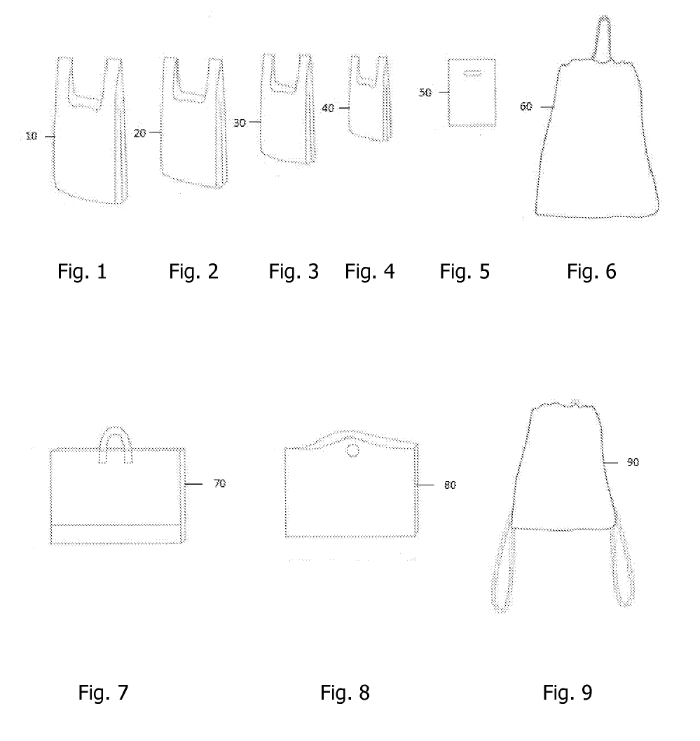

FIGS. 1-4 show embodiments of T-sacks 10-40 of different sizes.

FIG. 5 shows a die cut bag 50.

FIG. 6 shows a drawstring bag 60.

FIG. 7 shows a loop handle bag 70.

FIG. 8 shows a wave style bag 80.

FIG. 9 shows a drawstring bag 90.

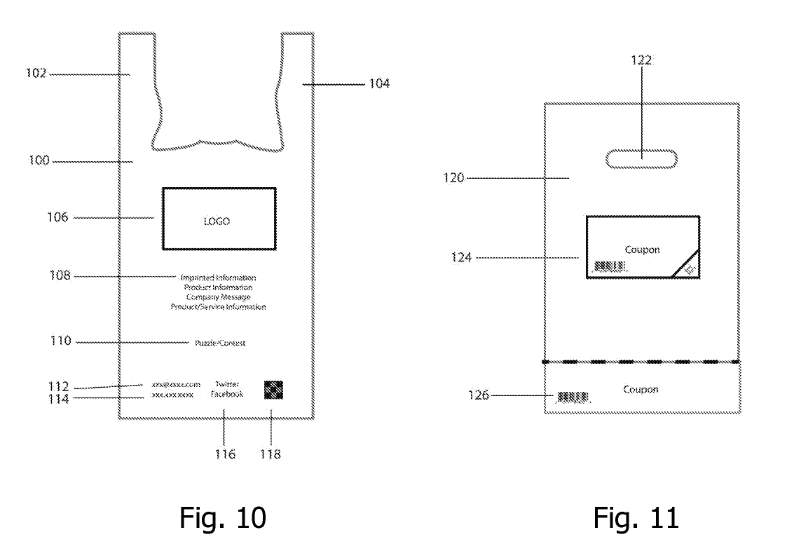

FIG. 10 shows a T-sack 100 having handles 102 and 104; logo 106; printed information, such as a company message, or product or service information 108; a puzzle or contest 110; website information 112; phone number 114; social media link to a portal such as, Twitter or Facebook 116; and QR Code 118.

FIG. 11 shows a die cut bag 120, having a die cut handle 122, a coupon 124 that can be peeled off of the bag 124, and a coupon 126 that can be cut from the bag 120.

In an embodiment the T-sack and/or T-shirt bags have a width of approximately 5″ to 20″, a height from 10″ to 40″ and a gusset from 2″ to 15″, with thickness ranging from approximately 0.25-4.0 mil.

In an embodiment the die cut bags have a width of approximately 5″ to 30″, a height from 5″ to 30″ and a gusset from 0.5″ to 15″, with a bag thickness of approximately 0.35 to 10.0 mil.

In an embodiment the loop handle bag has a width from about 3″ to about 30″, a height of 45″ to about 30″ and a gusset from 0.5″ to 15″, with a bag thickness of approximately 0.35 to 10.0 mil.

In an embodiment the tri-fold handle bag has a width from about 3″ to 30″, a height from 54″ to 30″ and a gusset from 0.5″ to 15″, with a bag thickness of approximately 0.35 to 10.0 mil.

In an embodiment the soft loop flat bag has a width of about 3″ to 30″ and a height from 5″ to 30″, with a bag thickness of approximately 0.35 to 10.0 mil.

In an embodiment the wave style bag has a width from about 3″ to 30″, a height from 5″ to 30″ and a gusset from 0.5″ to 15″, with a bag thickness of approximately 0.35 to 10.0 mil.

In an embodiment the drawstring bags have a width from about 5″ to 30″, a height of 5″ to 30″ and a gusset from 0.5″ to 15″, with a bag thickness of approximately 0.35 to 10.0 mil.

In an embodiment the drawstring cord bag has a width from about 5″ to 30″, a height of 5″ to 30″ and a gusset of 0.5 to15″, with a bag thickness of approximately 0.35 to 10.0 mil.

In an embodiment the bag comprises approximately 47-50% CaO₃, approximately 40% HDPE, approximately 10% LLPPE, and a filler/bonding agent of approximately 0-3%.

In an embodiment, the filler/bonding agent comprises an ester such as a long-chain (waxy) aliphatic ester. In a preferred embodiment, the filler/bonding agent is a waxy substrate such as a tallow based wax.

In an embodiment the CaCO₃ is approximately 20-30% of the weight of the composition for the bag.

In an embodiment the HDPE and LLDPE are pre-blended and extruded into pellets.

In an embodiment approximately 35-40% CaCO₃ is used by weight for the composition of the bag.

Independent lab tests done on a 1.0 mil thick Medium T-sack made with 25-35% CaCO₃, show that the T-sack performs just as well, if not better than a standard T-sack made with a polyethylene blend and approximately 5-10% CaCO₃. Tests performed include tensile strength and elongation (ASTM D882), tear resistance (ASTM D1922), and puncture force (ASTM D5748-01).

Regarding the 1.0 mil thick Medium T-sack made with 25-35% CaCO₃, the tensile strength and elongation test done in the length direction showed a maximum load ranging from 3.25 to 4.25 lbf, with the elongation break ranging from 325% to 400%. The tensile strength and elongation test done in the width direction showed a maximum load ranging from 2.75 to 3.0 lbf, with the elongation break ranging from 550% to 625%.

Regarding the 1.0 mil thick Medium T-sack made with 25-35% CaCO₃, the tear resistance test done in the length direction showed results ranging from 15 to 18 g. The tear resistance test done in the width direction showed results ranging from 300 to 360 g.

Regarding the 1.0 mil thick Medium T-sack made with 25-35% CaCO₃, the puncture force test done showed a maximum load ranging from 4.1 to 5.1 lbf.

1. A plastic bag comprising:
approximately 20-49% calcium carbonate;
approximately 30-60% high density polyethylene;
approximately 0-20% linear low density polyethylene;
approximately 0-10% fillers/bonding agent;
said plastic bag being a single layer.

2. The plastic bag of claim 1 further comprising a biopolymer.

3. The plastic bag of claim 2 wherein said biopolymer is approximately 5% to 20% by weight of said plastic bag.

4. The plastic bag of claim 2 wherein said biopolymer is an amount less than 1.5%.

5. The plastic bag of claim 2 wherein said biopolymer is selected from the group consisting of: poly lactic acid, poly-hydroxybutanoate, poly-hydroxyalkanoate, Nylon 610, Nylon 611.

6. The plastic bag of claim 1 wherein said bag contains no fibers.

7. The plastic bag of claim 1 wherein said external surface of said plastic bag has a printable surface.

8. The plastic bag of claim 1 wherein said external surface of said plastic bag has a smooth surface.

9. The plastic bag of claim 1 wherein said plastic bag provides a moisture barrier.

10. The plastic bag of claim 1 wherein said bag is biodegradable.

11. The plastic bag of claim 1 wherein said bag is a T-sack or T-shirt bag.

12. The plastic bag of claim 1 wherein said bag is a, die cut bag, loop handle bag, tri-fold handle bag, soft loop flat bag, wave style bag, drawstring bag or drawstring cord bag.

13. The plastic bag of claim 1 wherein said bag comprises printed information.

14. The plastic bag of claim 1 wherein said bag comprises a barcode.

15. The plastic bag of claim 1 wherein said bag comprises a coupon.

16. The plastic bag of claim 2 wherein said plastic bag is compostable.

17. A plastic bag comprising:
approximately 20-49% mineral material;
approximately 30-60% high density polyethylene;
approximately 0-20% linear low density polyethylene;
approximately 0-10% fillers/bonding agents;
said plastic bag being a single layer.

18. The plastic bag of claim 17 wherein said mineral material is selected from the group consisting of calcium carbonate, calcium sulfate, barium sulfate, kaolin, mica, zinc oxide, dolomite, glass fiber, hollow glass microbead, silica, chalk, talc, pigment, titanium dioxide, bentonite, clay, zeolite, slate, diatomaceous earth and combinations thereof.

19. The plastic bag of claim 17 further comprising a biopolymer.

20. The plastic bag of claim 19 wherein said biopolymer is approximately 5% to 20% by weight of said plastic bag.

21. The plastic bag of claim 19 wherein said biopolymer is an amount less than 1.5%.

22. The plastic bag of claim 19 wherein said biopolymer is selected from the group consisting of: poly lactic acid, poly-hydroxybutanoate, poly-hydroxyalkanoate, Nylon 610, Nylon 611.

23. The plastic bag of claim 17 wherein said bag contains no fibers.

24. The plastic bag of claim 17 wherein said external surface of said plastic bag has a printable surface.

25. The plastic bag of claim 17 wherein said external surface of said plastic bag has a smooth surface.

26. The plastic bag of claim 17 wherein said plastic bag provides a moisture barrier.

27. The plastic bag of claim 17 wherein said plastic bag is biodegradable.

28. The plastic bag of claim 17 wherein said bag is a T-sack or T-shirt bag.

29. The plastic bag of claim 17 wherein said bag is a, die-cut bag, loop-handle bag, tri-fold bag, soft loop flat bag, wave style bag, drawstring bag or drawstring cord bag.

30. The plastic bag of claim 17 wherein said bag comprises printed information.

31. The plastic bag of claim 17 wherein said bag comprises a barcode.

32. The plastic bag of claim 17 wherein said bag comprises a coupon.

33. The plastic bag of claim 19 wherein said plastic bag is compostable.

34. A plastic bag comprising:
approximately 25-40% calcium carbonate;
approximately 30-50% high density polyethylene;
approximately 5-15% linear low density polyethylene;
approximately 2-7% filler/bonding agent;
said plastic bag being a single layer.

35. The plastic bag of claim 34 further comprising a biopolymer.

36. A plastic bag comprising:
approximately 20-49% mineral material;
approximately 30-60% high density polyethylene;
approximately 0-20% low density polyethylene, linear low density polyethylene or a combination thereof;
approximately 0-10% fillers/bonding agent;
said plastic bag being a single layer.

37. The plastic bag of claim 36 further comprising a biopolymer.

38. A plastic bag comprising:
calcium carbonate;
high density polyethylene;
linear low density polyethylene; and
a filler/bonding agent;
said plastic bag being a single layer.

39. The plastic bag of claim 38 wherein said calcium carbonate comprises less than 50% by weight of said bag.

40. The plastic bag of claim 38 further comprising a biopolymer.

41. A plastic bag comprising:
calcium carbonate;
high density polyethylene;
low density polyethylene, linear low density polyethylene or a combination; and
a filler/bonding agent;
said plastic bag being a single layer.

42. The plastic bag of claim 41 wherein said calcium carbonate comprises less than 50% by weight of said bag.

43. The plastic bag of claim 41 further comprising a biopolymer.
